(19) United States
(12) Patent Application Publication
(10) Pub. No.: US 2008/0040430 A1
(43) Pub. Date: Feb. 14, 2008

(54) System and method to facilitate operating a media-playing set

(75) Inventor: Vishnu Kumar Shivaji-Rao, Vancouver, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/503,041

(22) Filed: Aug. 10, 2006

(51) Int. Cl. G06F 15/16

(52) U.S. Cl. 709/205

(57) ABSTRACT

A system and corresponding method to facilitate operating a media-playing set with a display provides a storage device, a collection component transferring personal preference information to the storage device about the broadcast preferences of the user including personal program and setting information, and an access component enabling user access to such preference information for a particular day and time such that information identifying at least one of the programs and individually identifying at least two of the settings for that program are presented on the display. The same where the storage device is remotely located, where the user is prompted for the set's geographical location, where personal preference information is collected from other related users from which community preference information is calculated, and/or where the user can either adopt the given personal preference settings, independently adjust each setting interactively on-screen, or elect corresponding community preference settings.

### CROSS-REFERENCE TO RELATED APPLICATIONS

Not Applicable.

### BACKGROUND OF THE INVENTION

The present invention relates to a system and method to facilitate operating a media-playing set and relates, in particular, to a system and method facilitating selection of programming for the set and appropriate settings for that programming.

As technology has progressed, the tendency has been for media-playing sets to accept programming from an ever increasing variety of media sources and to provide an ever expanding range of operational controls. For example, one type of media-playing set, the television, in one of its earlier forms, was a standalone unit receiving a handful of air broadcast channels and having a few basic controls, such as a channel selector and on/off knob turnable for volume adjustment. In contrast, a modern television set is typically connectible with other standalone products, such as a personal computer, videocassette recorder, digital video disc recorder, compact disc player, or stereo, to form a larger entertainment system and accepts signals from a variety of external sources, including air broadcast, satellite, and cable, so that the number of channels and programs can number into the hundreds. Also, typically an on-screen control menu is provided by the set offering greatly expanded choices for adjusting different aspects of the picture, sound, and other operational features so that these features can be better adapted to the various media and program formats available. Moreover, hybrid forms have appeared including televisions able to process digitized signals, such as in MPEG-2 or -4 format, and computers or miniplayers able to process television or other media broadcasts via a tuner card or through upstream conversion to digitized format.

When faced with the sometimes bewildering number of programs available with a modern set, a user can experience difficulties in deciding which particular program to select. To guide the user in making a selection, various aids have been developed. One early form was a printed program guide listing the broadcast channels potentially available locally with a breakdown, by day and time, of the programming provided on each channel identified by label or brief description. A more recent adaptation of this is the Electronic Programming Guide (EPG), an on-screen version of a program guide where, for example, the channels correspond to different rows, the current and closely following time slots correspond to different columns, and the intersecting cells contain program information possibly expandable by hyperlink. Some of the data populating the program information can be extracted from the metadata (data about data) that is often broadcast with particular program segments and that typically includes, for example, a representative title page, program theme, creation date, names of directors and actors, and perhaps a program synopsis.

The channels included in the EPG may be selected based on various criteria. They may represent all potential channels, in which case the user once again is presented with a bewildering array of choices. They may be limited to channels previously viewed by the user; however, the processing, memory, and software resources needed to track the user's previous viewing habits can raise the cost of manufacturing each set to prohibitive levels. They may be limited to channels favored by outside experts or by other users as determined, for example, by reviews or ratings; however, there is some question in such systems whether the subjective tastes of such experts or other users will match the preferences of the individual user.

After selecting a channel, normally it is desirable that the user adjust the settings so that they are appropriate for the program being viewed. For example, a higher contrast setting may be appropriate for a sports program so that a small ball in play can be easily followed, whereas a lower contrast setting may be appropriate for an old movie to help hide the scratches and blemishes that accumulate in older films. However, finding a group of settings suitable for watching a particular program can be more tedious and protracted a process than even finding a suitable channel. A cumbersome trial-and-error approach is often used so that, for example, the user goes back-and-forth between an adjustment mode in which one of the possible picture or sound settings is changed from one value to another and a broadcast mode in which the user evaluates the effect of the change on the program being broadcast, with the process being repeated as many times as needed until suitable values are found for each setting. Further complicating the process is the potentially adverse effect that adjustment of some settings can have on related settings; for example, the optimal setting for brightness may significantly degrade the best achievable setting for contrast so that a compromise setting for each may actually be best when both are considered together. In order to avoid these difficulties, some sets provide predefined groups of mutually compatible settings; however, such settings are normally provided for only a limited number of program types, such as old movies, sports, cartoons, and games, and may not reflect those idiosyncrasies that distinguish a particular user's tastes.

Accordingly, a principal object of the present invention is to provide a system and method enabling a user to select suitable programs and settings for those programs on a media-playing set more efficiently and with better results than previously possible.

### BRIEF SUMMARY OF THE INVENTION

In accordance with a first aspect of the present invention, a system to facilitate operating a media-playing set including a display is provided comprising a storage device; a collection component to transfer personal preference information to the storage device about the broadcast preferences of the user including personal program information identifying respective programs selected by the user indexed by day and time broadcast and personal setting information identifying at least certain of the settings favored by the user for each respective program; and an access component enabling the user to selectively access the storage device to recall a portion of the personal preference information associated with a particular day and time such that on the display certain of the personal program information is presented identifying at least one of the respective programs and certain of the personal setting information is presented individually identifying at least two of the settings favored by the user for such at least one of the respective programs.

This first aspect provides a system enabling the user to recall, by day and time, particular programs that, being based on previously recorded information capturing the particular preferences of the user, are likely to be well-suited for current viewing and/or listening. Moreover, the significant settings previously favored by that user for each recalled program are presented in such a fashion that the user can easily identify and further adjust the settings or, if preferred, simply adopt the settings which, in effect, have already been prescreened by the user for suitability with the corresponding program.

In accordance with a second aspect of the present invention, a method to facilitate operating a media-playing set including a display is provided comprising the steps of providing a storage device; transferring personal preference information to the storage device about the broadcast preferences of the user including personal program information identifying respective programs selected by the user indexed by day and time broadcast and personal setting information identifying at least certain of the settings favored by the user for each respective program; and enabling the user to selectively access the storage device to recall a portion of the personal preference information associated with a particular day and time including presenting on the display certain of the personal program information identifying at least one of the respective programs and certain of the personal setting information individually identifying at least two of the settings favored by the user for such at least one of said respective programs.

This second aspect provides a method enabling the user to conveniently locate, for a particular day and time, programs that the user is likely to find suitable for current broadcast and, moreover, to identify suitable settings for such programs. These settings are already selected to be closely aligned with the user's distinctive preferences based on the user's own viewing or listening patterns so that, consistent with maximum convenience to the user, they can simply be adopted as presented without any further need for tedious or cumbersome adjustment procedures. Further advantages relating to other aspects of the present invention will be evident from the detailed description provided below taken in conjunction with the accompanying drawings.

### BRIEF DESCRIPTION OF THE SEVERAL VIEWS OF THE DRAWINGS

FIG. 1 is a diagrammatic view of an exemplary system to facilitate operating a media-playing set as constructed in accordance with the present invention.

FIG. 2 is a schematic view showing details of the system of FIG. 1.

FIG. 3 is a flowchart outlining an exemplary method for facilitating the operation of a media-playing set.

FIG. 4 is a plan view showing an exemplary on-screen control menu displayed on the media-playing set of FIG. 1 in accordance with the present invention.

FIG. 5 is a plan view of the exemplary on-screen control menu of FIG. 4 with a different channel selected resulting in a different group of preferred settings.

FIG. 6 is a plan view of the exemplary on-screen control menu of FIG. 5 with a different time selected resulting in a different preferred channel and different group of preferred settings.

### DETAILED DESCRIPTION OF PREFERRED EMBODIMENT

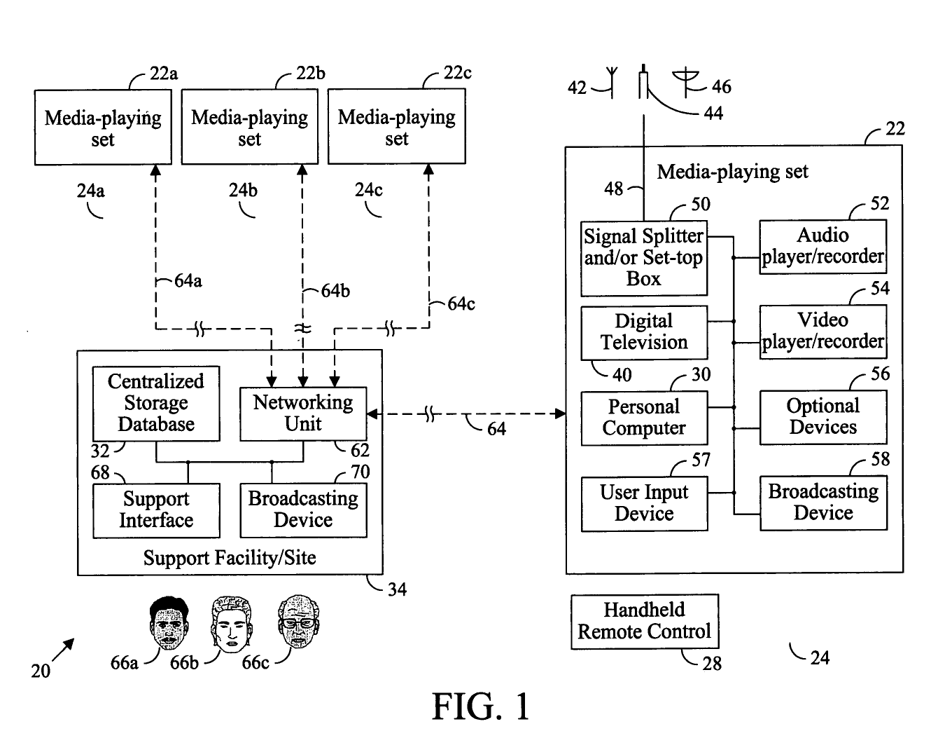

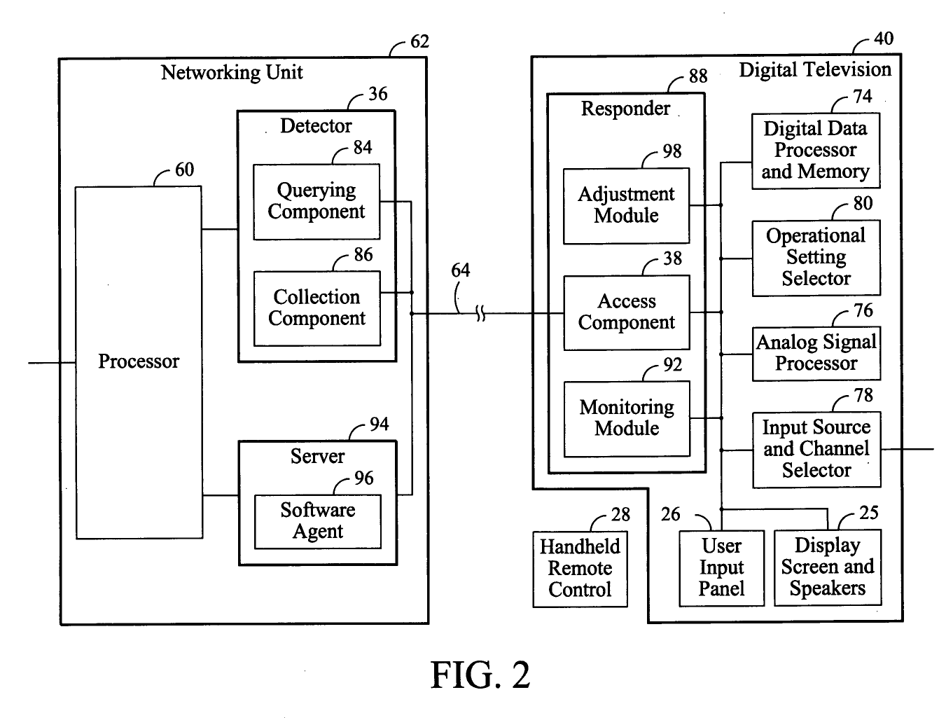

FIG. 1 shows, in functional block-diagram form, an exemplary system 20 constructed in accordance with the present invention to facilitate operation of a media-playing set 22 by an end user 24. Specifically, the system is designed to facilitate channel or program selection by the user and also to facilitate adjustment of the operational settings used for each channel or program. Referring also to FIG. 2, the user is able to adjust various operational settings of the set, such as the picture and sound settings that govern operation of the display screen and speakers 25, using one or more control devices. These devices can include an input panel 26 on the console of the set, a handheld remote control 28, or the mouse and keyboard devices of a personal computer 30 interacting with an on-screen control menu. Operational settings relating to picture may include backlight, contrast, brightness, color, tint, sharpness, and so on; operational settings relating to sound may include, for example, treble, bass, and balance.

An important component of the exemplary system is a centralized storage device or database 32 included at a support facility or site 34 located remotely from the set 22 of the user 24 and the respective sets 22a, b, and c of other geographically distributed end users 24a, b, and c. Acting in conjunction with a detector 36 also located at the remote facility, this storage device allows cost-effective capture of historical information about the viewing or listening preferences preferably both of the end user and of the other end users. This preference information includes information identifying preferred programs and also information about preferred settings for each preferred program favored by the user and the other end users. An access component 38 included on the set enables the user, when desired, to access the remote storage device to recall the personal preference information for a particular day and time. This information is presented on the display so as to identify at least one preferred program and so as to identify at least two of the settings favored by the user or user community for that program. These significant features of the exemplary system will be more fully described below.

In the exemplary embodiment depicted in FIG. 1, the media-playing set 22 is a full-featured consumer entertainment system including a number of separately purchasable components and designed to receive signals from a variety of different sources. The heart of the set depicted is a digital television 40 which receives external signals from an air antenna 42, cable link 44, or satellite link 46 through an external feed 48 by way of a signal splitter and/or set-top box 50 so that multiple signals are fed into the television. The television also receives input signals from various connected peripherals including, for example, from a compact disc (CD) or other audio player 52, from a combined video cassette recorder (VCR) and digital video disc (DVD) player or other video player 54, and from a game console, camcorder, digital videorecorder home system or other optional device 56. A digital video interface (DVI) input/control signal is supplied from the personal computer 30. The user input device 57 includes the user input panel 26 on the television's console, the mouse and keyboard of the computer, and may include an RS-232C connection. The broadcasting device 58 includes the television's display screen and speakers 25 and any other output devices such as standalone quad speakers. The benefits of the present invention are most fully realized in the context of a full-featured media-playing set of the type described insofar as proper adjustment of the set becomes more difficult as the variety of signal sources and types increases; however, the term “media-playing set,” as used herein and in the claims, is also intended to encompass less elaborate, unitary systems such as personal digital assistants (PDA's) having media access through a network.

In the exemplary system 20 depicted in FIG. 1, the storage database 32 is located off-site from each set at a remote support facility or site 34. This database is used to hold historical information about the broadcast preferences of the user 24 and of the other end users 24a, b, and c, where the term “broadcast preferences,” as used herein and in the claims, is intended to signify viewing and/or listening preferences. Referring also to FIG. 2, this storage database or memory is controlled or governed by a processor 60 included in a networking unit 62. The networking unit is electronically connected with each set, preferably over temporary network lines 64 and 64 a, b, and c. These may comprise conventional phone lines established by dial-up operation from each set. Preferably, a secure and readily recognizable communications protocol is used such as secure sockets layer (SSL) technology with data formatted in extensible markup language (XML). The processor is preferably programmed to control incoming and outgoing data to and from the networking unit, in accordance with the preferred operations later described, and to govern access to the storage database so that the operations of the remote support facility relating to the present invention are conducted substantially automatically. If desired for other purposes, the remote support site 34 can, however, be staffed by customer service representatives 66a, b, and c, trained, for example, to answer telephone inquiries and to direct operations at the site with the aid of a support interface 68, such as computer terminals, and a broadcasting unit 70, such as display screens and speakers replicating the images and sounds currently exhibited at the user's set. In any event, the support facility provides a centralized site for remotely monitoring and controlling the operation of the media-playing set 24 of the indicated user as well as the respective sets 24 a, b, and c of the other users 22 a, b, and c. It is to be understood that data may be stored at the television.

The storage database 32, as noted above, is located remotely from each set 24 or 24 a, b, and c, but is selectively connectible electronically to each set indirectly through the networking unit 62. The term “remotely,” as used herein and in the claims, is intended to denote that the database is not physically accessible to any user in the home or quarters where the set is located. Although it is possible, in accordance with at least certain embodiments of the invention, to provide each set with its own database for storing viewing preferences, this alternative approach is less advantageous. Centralizing the memory resources in the exemplary manner described reduces maintenance and upgrade costs and reduces the manufacturing cost of each set by limiting the memory and processing capacity that would otherwise be separately needed at each set. Also, this centralized arrangement allows the preference information from all the geographically distributed users to be conveniently collected in one place, thereby facilitating grouping of each user with other users of like demographic status and permitting, in turn, each user's personal preference information to be supplemented with relevant community preference information. Moreover, as no user has direct physical access to the storage device, the personal preference information of each user is better secured against unauthorized eavesdropping or tampering by any other user.

FIG. 2 depicts certain details of the digital television 40 and remote networking unit 62 which, as noted above, are selectively connected together via a temporary network line 64. This connection is established, for example, when a dial-up connection is made by personal computer 30 (FIG. 1) to the networking unit, the computer being connected, in turn, to the digital television through the digital video interface (DVI) control/signal line. The digital television conventionally includes a digital data processor and memory 74 to demodulate, decode, and process the digital signal input, an analog signal processor 76 for demodulating and processing the analog signal input, an input source and channel selector 78 for selecting between input sources and channels, and an operational setting selector 80 for adjusting and maintaining the operational settings of the set, such as relate to picture and sound characteristics.

In the present context, the general function of the remote networking unit 62 is to detect or track the usage pattern at each set, to evaluate this pattern, and, based on this evaluation, to interactively respond to user requests for preference information by remotely driving the set so that suitable program and setting information is presented on the display screen 25. The remote networking unit includes the detector 36 having a querying component 84 that continually polls or submits query requests to the set and a collection component 86 for receiving the resulting status information. These requests are handled at the set by a responder 88 where they are received by the access component 38 and relayed to a monitoring module 92. The monitoring module monitors the current status of the source/channel and operational selectors, 78 and 80, and, if no network line 64 between the set and networking unit is currently open, also provides temporary storage for recording the user's previous selections for source, channel, and operational settings. Responding to the remote request, the monitoring module sends back the current and any previously uncollected information to the access component for transmission or transfer to the remote collection component. The querying component could, alternatively, reside on the set so that the collection of status information is initiated locally or such collection could be event-driven rather than continual. In any event, the source, channel, and operational settings of the set and any changes to such settings are relayed by the detector to the processor which, after organizing this information in the manner further described below, passes it to the centralized storage database 32 for recording.

In response to the user requesting guidance in selecting a program or setting, the exemplary networking unit 62 drives the set so that suitable program and setting information is presented on the display 25. The user can selectively make such request by, for example, pressing a “recall preferences” button on the handheld remote control 28 or a similarly labeled menu item on an on-screen control menu. This, in turn, causes the access component 38 to submit a request for preference information to the remote networking unit. In response, the processor 60 accesses the relevant portion of preference information previously recorded in the storage database 32, for example, that portion matching the current day and time, and passes this information to a server 94. The server includes a software agent 96 for suitably formatting the information for transfer to the access component. The access component passes the returned information to an adjustment module 98 which directs the digital data processor and memory 74 to render the preference information for presentation on the display screen 25. In at least one alternative embodiment, storage and retrieval of the preference information may be done using a storage database and processor locally provided at the set; however, as noted above, it is preferable to locate these resources off-site for reasons of informational flexibility, upgradeability, security, and cost economy. More generally, in connection with FIGS. 1 and 2, it will be noted that the components shown are so depicted for ease of illustration and description and that these functional components can be combined or divided differently than shown without substantially departing from at least the broader aspects of the present invention.

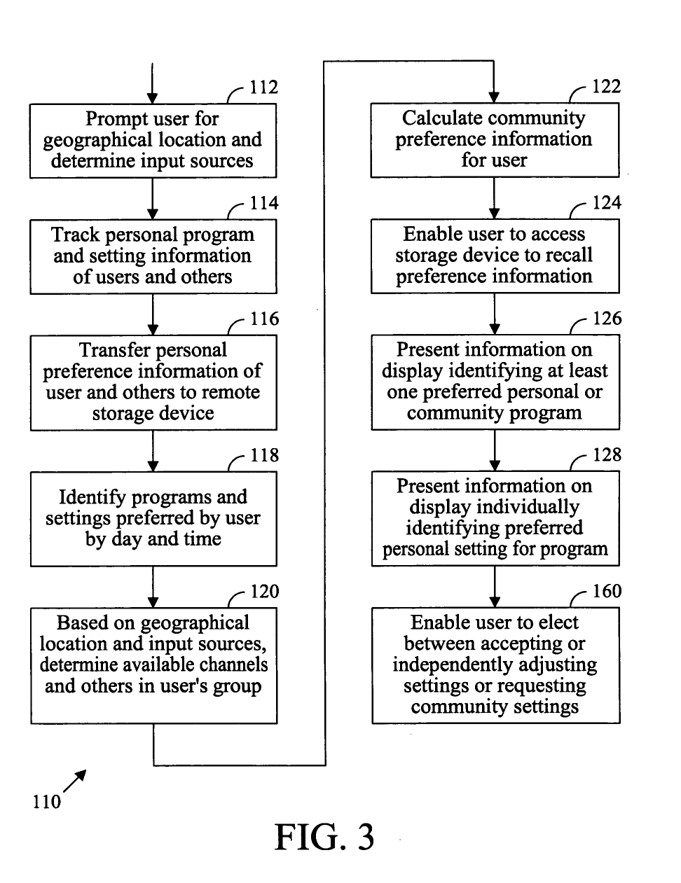

FIG. 3 outlines an exemplary method 110 comprising a series of steps or operations preferably performed by the exemplary system of FIGS. 1 and 2. To initiate the process, the user presses a “recall preferences” button on the handheld remote control 28 or uses the mouse device of the personal computer 30 to select a similarly labeled item from an on-screen control menu. If remote connection is not already established, the personal computer 30, which is connected to the digital television 40 via a DVI line, makes a dial-up connection to the remote networking unit 62 via temporary network line 64 so that connection is established, in turn, between the remote networking unit and the digital television 40.

Step 112 involves prompting the user for the geographical location of the set and also determining which specific input sources the set is connected to. Referring to FIG. 2, after receiving notification that a connection has been established, the processor 60, in automatic mode, directs the querying component 84 to present a location request to the set so as to cause a visual prompt to be shown on the display screen 25 explicitly asking the user to identify the geographical location of the set. For example, the prompt may direct the user to enter the zip code of the location where the set is located using the numerical buttons on the handheld remote control 28 or the keypad on the computer 30.

The processor 60 also directs the querying component 84 to query the set to determine which input source or sources the user is currently using and the model number of the set. In the exemplary embodiment of FIG. 2, for example, this query is submitted to the access component 38, which relays it to the monitoring module 92. The monitoring module confirms which input sources are selected at the input source and channel selector 78. For example, the input source on one channel of the set may constitute an air broadcast antenna 42 and on another channel, a satellite link 46, or, instead, the input source may be internal such as an audio player or stereo 52 delivering audio-only programming to the set. The requested information is returned to the processor through access component 38 and collection component 86.

With the information about the set's geographical location, current input sources, and model type as well as with information provided by commercial compilers of regional programming guides, the processor 60 can identify which programs are likely available for the set. The processor 60 may further automatically verify that any program included in the preference information presented to the user is on this list. This information also enables the processor to group the user with other users of like demographic so that relevant community preference information can be provided to the user as further described below.

Step 114 involves tracking or capturing the personal preference information, as it relates to both programs and settings, of the subject user and of other users so that this information can be processed and later presented to guide the user in making future selections. Upon suitable query by the remote querying component 84, the access component 38 returns this information to the collection component 86. The access component is provided this information from the monitoring module 92 which obtains the current settings from the operational setting selector 80, the current program from the input source and channel selector 78, and which also stores and returns historical information about settings and programs previously selected by the user from the time of the last query. Programs can be identified by channel number, station call letters, program name or theme, such as “Oprah” or “Cartoon,” or by a combination of one or more of these items. An example of personal preference information of the type collected is that at 9:00 p.m. on Monday evening, the user selected station NBC, channel 8, to watch “The Apprentice,” using the following settings: AV mode at “Dynamic,” Volume at “20,” Color at “−23,” Bass at “−3,” and Backlight at “12.” Filtering is desirably performed, either remotely by the processor 60 or, preferably, locally by the monitoring module 92, so that only information on programs or settings that the user likely has a preference for are captured. For example, if the user is quickly switching through channels or settings, such transient selections are desirably excluded from retention or capture.

Referring to step 116, the personal preference information of both the subject user 24 and the other geographically distributed users 24a, 24b, and 24c is transferred by processor 60 to the remote storage device or database 32 for recording. In the exemplary embodiment of FIG. 2, the monitoring module 92 is then reinitialized or cleared to free up space for capturing further preference information. The processor 60 operates on the information thus recorded, as indicated by step 118, to identify and to rank the programs and settings preferred by each user by day and time. Both programs and settings can be ranked based on absolute count or on frequency of occurrence within a given period; if desired, various weighting strategies can be used as well. For example, if on Saturday at 9:00 a.m., channel 60 was watched 9 times or 75% of the time in the last quarter whereas channel 70 was watched three times or 25% of the time, then for that day and time, channel 60 would be given a higher ranking. On the other hand, if, for the same day, time, and period, channel 60 was watched four times, channel 65 twice, channel 68 once, and channel 70 five times, and if the processor further determines, based on regional program guide information or metadata carried with each show, that channels 60, 65, and 68 are all “cartoons” whereas channel 70 is a sports fishing show, then the processor would rank channel 60 higher. Though channel 70 has the higher absolute count before adjustment, after adjustment, the count for channel 60 is actually higher because a higher weighting is given to the count of channel 60 due to its sharing a common theme (cartoons) with other user-selected programs of the same day and time. This example also clarifies that the term “user” is intended to broadly refer to anyone in a particular user's household including, for example, children, and not just to one individual within a household. Higher weights can also be assigned, for example, to those programs selected nearly on the hour or half-hour as this tends to show a conscious attempt by the user to tune to a favored program so as to avoid missing any part of the program.

After being ranked by likely preference level, the personal preference information for each user is then resaved to the storage device or database 32. This personal preference information, that is, the ranked listing of respective programs previously selected personally by the user and the settings favored by the user for each of those programs, is preferably organized or indexed in memory by day and time for convenient recall later.

The processor 60 not only maintains one record containing personal preference information for each user but also desirably develops and maintains a second companion record containing community preference information. This community information represents the consolidated viewing preferences of those other users deemed likely to have similar preferences as the subject user as based, for example, on their similar demographic characteristics and similar exposure to potential choices as concerns channels and settings. This community preference information forms a supplement to and, for those days and times where no personal information is available, a substitute for, the user's own personal preference information. Indeed, even when personal preference information is available, the user may prefer community preference information at certain times, for example, when the user tires of repeatedly watching the same programs or when the user has previously adopted certain settings only out of frustration at finding better settings.

The process of calculating the community preference information for the subject user begins, as step 120 indicates, by identifying the subject user's group or community. In the exemplary embodiment, two relationships are considered in determining if particular users belong to the same group or community: 1) congruence among these users as to channels and settings available and 2) congruence among these users as to likely preferences. To determine which channels and settings are available to each user, the processor receives information about each user's geographical location, the input sources the user is currently using, the particular capabilities or type of set, and data contained in regional program guides. This information is collected using various approaches including explicit query of each user for their zip code in order to identify location, remote monitoring to identify input sources and model type, and recourse to outside compilers for regional program guide information. By comparing the subject user's list of available channels and settings to those of other user's, the processor can identify a first subgroup of other users whose available choices for programs and settings closely corresponds to the subject user's.

The processor 60 then determines who in the first subgroup are likely to share the same program and setting preferences as the subject user. Here a presumption is made that those individuals possessing socioeconomic status comparable to the subject user are most likely to share the subject user's preferences. Socioeconomic status, in turn, can be roughly correlated to zip code as available from census and other publicly accessible data. From such information, then, the processor 60 is able to identify a second subgroup of individuals who, being of comparable socioeconomic status with the subject user, likely share the subject user's preferences and who, being selected from the first subgroup, likely possess similar choices. In this manner, in accordance with step 120, the processor identifies a subcategory of other users who, in sharing like characteristics with the subject user, form the subject user's group or community.

In accordance with step 122, the community preference information for the subject user can now be calculated. To do so, the processor 60 combines or aggregates the personal preference information of all the users who belong to the subject user's group or community. As noted above, this includes information relating to preferred programs and settings. This combined information is then ranked in like manner to that used for ranking the user's own personal preference information. The resulting data, which represents the community preference information for the subject user, is saved in the centralized storage database 32. For each user, then, there is a first saved record containing the user's own personal preference information and a second or companion saved record containing the user's community preference information. It may be noted that as new information is collected, both of these records are dynamically updated automatically by the processor.

Thus far, the steps described have related to the collection, processing, and storage of historical preference information for the user and other users. With step 124, the user begins to make current use of the preference information, first by accessing the storage device 32 to recall this information in order to help with the selection of a suitable channel or group of settings. In the exemplary system of FIGS. 1 and 2, for example, when the user wishes to recall the preference information, he or she presses a “recall preferences” button on the handheld remote control 28 or uses the mouse of personal computer 30 to select a similarly labeled on-screen menu item. This causes access component 38 to issue a request to the remote site 34 for the applicable portion of the preference information. This request is received by the collection component 86 and relayed to processor 60, which then pulls the appropriate information from the storage database 32. This information is passed to the server 94 for formatting by a software agent 96 and delivery back to the requesting set. If the user has not specified a particular day or time, then preferably the preference information delivered back is that portion associated with the current day or time.

After the preference information associated with a particular day and time has been recalled, certain of this information is presented on the set's display screen 25. Referring to steps 126 and 128, certain of the personal program information is presented identifying at least one of the respective programs previously viewed by the user and certain of the personal setting information is presented individually identifying at least two of the settings previously favored by the user for that respective program.

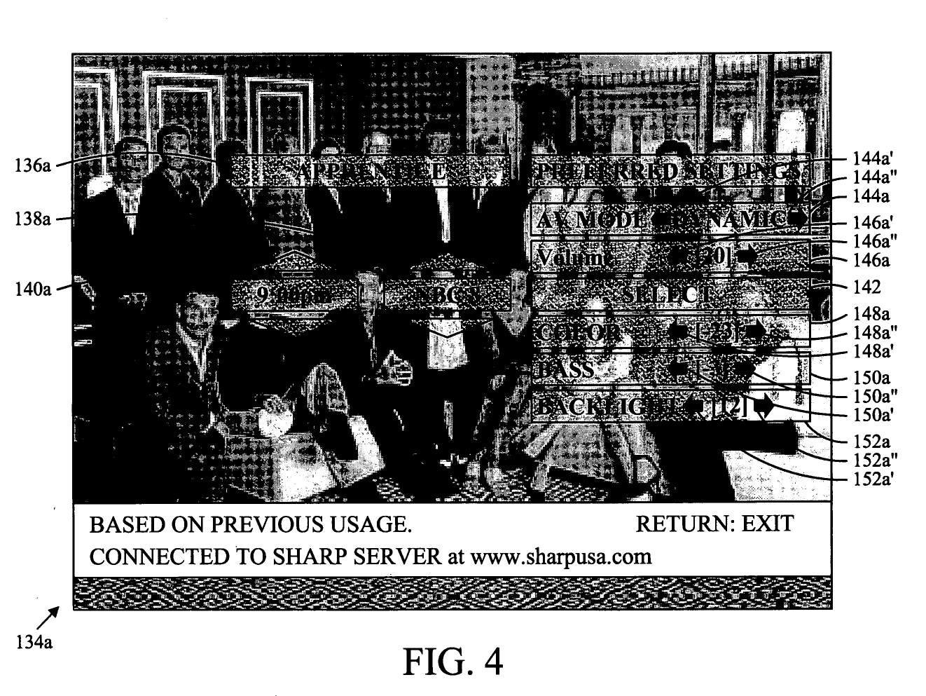

An exemplary on-screen presentation 134a of the type just described is depicted in FIG. 4. In this example, presumably to assist with current channel or setting selection, the user has requested recall or recovery of that preference information associated with 9:00 p.m. on Monday evening. For such day and time, at least one preferred program is identified on the display, specifically the top-ranked program. This identification is done both with a menu item 136a that specifies the program's name “Apprentice” and with a menu item 138a that specifies the corresponding station's call letters and channel number “NBC 8.”

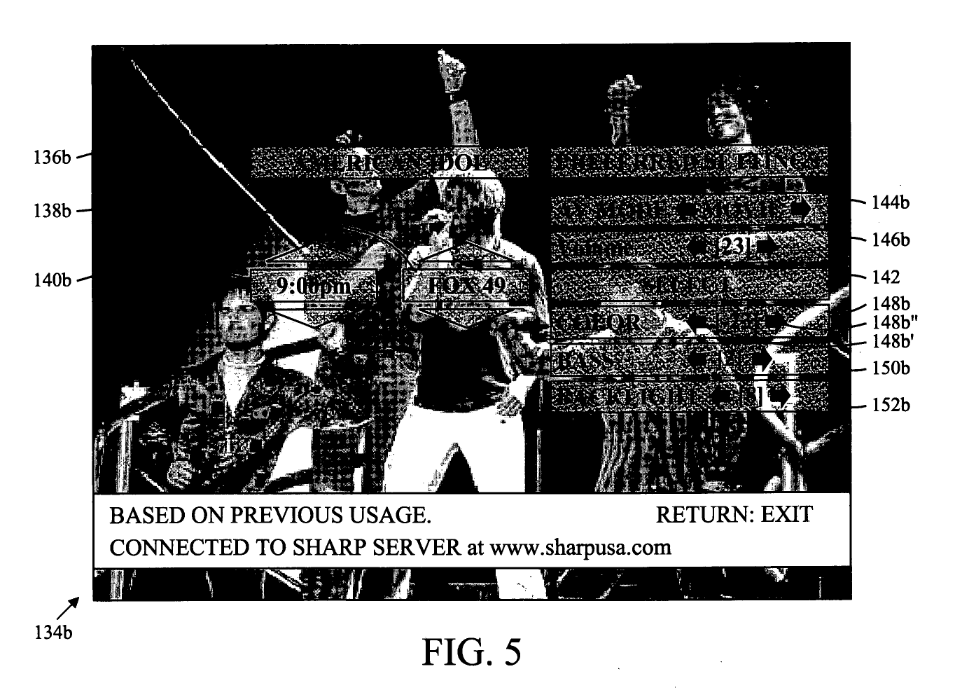

If the user “taps” either menu item 136a or 138a, such as by using the navigational and enter keys on the handheld remote control 28 or the mouse device of the personal computer 30, the adjustment module 98 cycles the display to the preferred program of the next highest rank. This is shown in FIG. 5 where menu items 136a and 138a have changed to 136b and 138b, respectively, so as to identify the next-highest ranked program by its program name “American Idol” and by its station call letters and channel number “Fox 49.” To set the background broadcast to this next highest ranked preferred program, the user taps the Select item 144. Otherwise, the user can continue tapping either one of the two menu items identifying the preferred program to consecutively advance through the entire ranked list of programs. After this list is exhausted, the user is automatically directed to the list of community preferred programs, as calculated in step 122, and likewise can consecutively advance through that ranked list (with duplications between the lists automatically omitted) by repeated tapping until returning, at last, to the initial screen shown in FIG. 4. It will be noted that each program presented is preferably first cross-checked against the list of available channels determined in step 120 so that specious programs are eliminated. It will also be noted that by using this cycling procedure, only limited space is occupied at any given time on the display by the preferred program information so that the remaining space can desirably be devoted to presenting detailed preferred setting options as further described below.

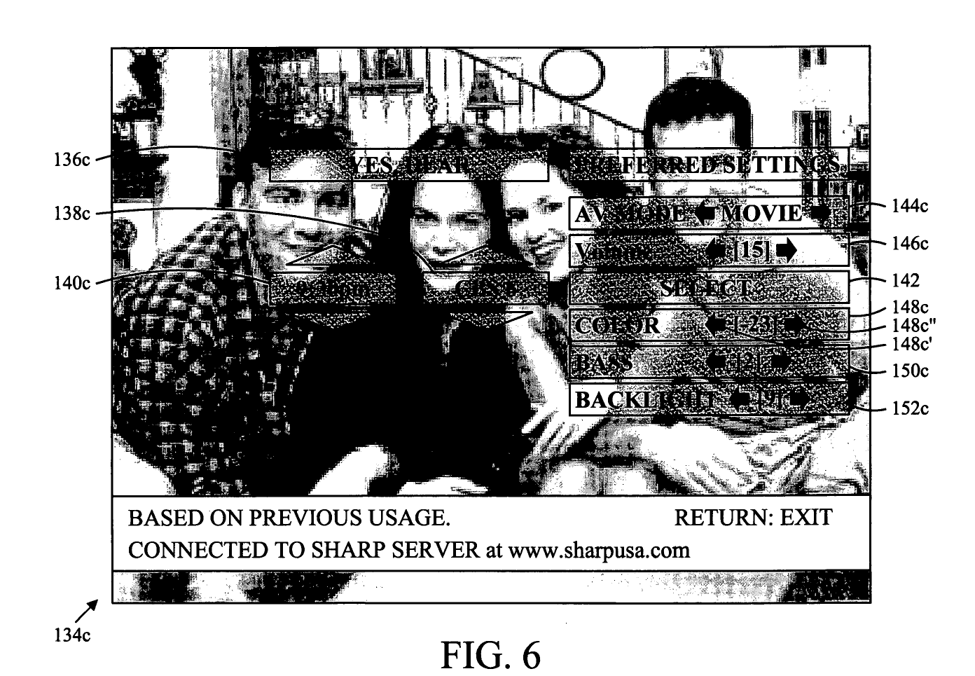

In like manner, the user can cycle through future time slots, for example, when seeking a suitable program to record at some future time. Thus, upon tapping menu item 140b in FIG. 5 reporting the 9:00 p.m. time setting, the user advances the time by one 30 minute interval to the 9:30 p.m. time setting, as reported by menu item 140c in FIG. 6. The menu items 136b and 138b correspondingly switch to 136c and 138c to identify the highest ranked preferred program for that time slot: “Yes Dear” on “CBS 6.”

As depicted by the exemplary on-screen presentation 134a of FIG. 4, for each menu item or items 136a and 138a identifying a preferred program, there are at least two and preferably more menu items individually identifying the preferred settings corresponding to that preferred program. In FIG. 4, these menu items 144a, 146a, 148a, 150a, and 152a relate to audiovisual (AV) mode (with “dynamic” being the default mode; other modes being available for old movies, sports, cartoons, or games), volume, color, bass, and backlight, respectively. As the user cycles through the ranked list of preferred programs, the preferred settings correspondingly change. Thus, whereas the preferred settings for the highest-ranked program “Apprentice” in FIG. 4 are “Dynamic” for the AV Mode, “20” for Volume, “−23” for Color, “−3” for Bass, and “12” for Backlight, for the next-highest ranked program “American Idol” in FIG. 5, the corresponding preferred settings are “Movie,” “23,” “−23” (unchanged), “2,” and “8,” respectively.

Individually identifying the preferred settings in this manner provides the user with the information needed to either accept the settings, as given, or to conveniently change each setting, if desired. For example, since a numerical value is provided for each setting, the user can immediately gauge where each setting currently lies within its range and how much room is left for further adjustment. Also, if the user is dissatisfied with a particular setting, say the color setting 148a, the user can change this setting by “tapping” either the “down” or “up” adjustment arrows 148a′ or 148a″, respectively, secure in the knowledge that he or she can always restore the original setting (i.e., “−23”) if the need arises. The user is not required, in particular, to somehow attempt to mentally isolate the individual effect of a member of an integrally manifested group of settings.

Preferably, as just described, adjustment of each setting can be conveniently and intuitively performed via direct interaction with the setting information presented on the display screen (e.g., by “tapping” the adjustment arrows while observing the resulting numerical change in setting value). Also, preferably, each operational setting can be flexibly adjusted independently of the other settings so that, for example, the user can adjust one setting only slightly while making a significantly greater adjustment to another. To this end, the menu items 144a, 146a, 148a, 150a, and 152a identifying the preferred settings each have their corresponding pair of up and down adjustment arrows 144a′ and 144a″; 146a′ and 146a″; 148a′ and 148a″; 150a′ and 150a″; and 152a′ and 152a″, respectively.

The exemplary system herein described also affords the user the option of presenting the community settings preferred by like users for the particular program selected. This is so whether or not, for example, the selected program itself derives from the user's personal preference information or, instead, from community preference information. This option does assume that the selected program is present on both the personal and community lists, an assumption that normally should hold unless the user's tastes are quite unusual. In reference to the exemplary screen of FIG. 4, for example, if the user attempts to individually adjust a setting, such as by tapping on “up” adjustment arrow 148a″, a popup screen appears asking if the user would first like to view the settings that have been favored for that same program by users like him- or herself. Hence, as indicated by step 160 of FIG. 3, when the user is initially presented with preselected personal settings for a respective preferred program, the user can elect to either 1) accept the preferred settings as given; 2) independently adjust each setting; or 3) request any community settings available for that same program.

It will be noted, under the last option just given, that the user is allowed to select a group of settings specifically tailored to the selected program without individually investing the time and effort that would otherwise be needed to obtain this result. It will further be noted that to the extent the users in a particular community settle on a particular group of settings as optimal, because the system dynamically updates the preference information automatically, these users are, in effect, effortlessly providing feedback as to which group of settings deserves the highest rating. Though it is unlikely an individual user will take the trouble to find the optimal group of settings for each selected program, it is quite possible that at least one user in the same community has gone through that effort, and the system is designed so that such effort is quickly recognized and utilized.

An exemplary system to facilitate the operation of a media-playing set has now been described which, in particular, facilitates convenient selection of a suitable program even where a bewildering number of choices exist and which also facilitates selection of a group of settings optimal for that program. It will be evident to those of ordinary skill in the art that at least certain substitutions and combinations other than those set forth above are possible and that the particular structures and operations described could be altered without, in fact, significantly deviating from the core teachings and essential elements of the present invention. The terms and expressions employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A system to facilitate operating a media-playing set including a display comprising:
(a) a storage device;
(b) a collection component to transfer personal preference information to said storage device about the broadcast preferences of said user including personal program information identifying respective programs selected by said user indexed by day and time broadcast and personal setting information identifying at least certain of the settings favored by said user for each respective program; and
(c) an access component enabling said user to selectively access said storage device to recall a portion of said personal preference information associated with a particular day and time such that on said display certain of said personal program information is presented identifying at least one of said respective programs and certain of said personal setting information is presented individually identifying at least two of the settings favored by said user for said at least one of said respective programs.

2. The system of claim 1 wherein said display is interactive such that said user can adjust each of said at least two of the settings by interacting with said setting information presented on said display.

3. The system of claim 1 further including a querying component to prompt said user for geographical information identifying the location of said set.

4. The system of claim 1 further including a cycling component enabling said user to consecutively cycle between respective programs included in said personal program information presented on said display for said particular day and time.

5. The system of claim 1 wherein said storage device is remotely located from and electronically networked with said set and other sets such that preference information is transferable to and accessible from said storage device by geographically distributed other ones of said users.

6. The system of claim 5 further including a processor enabling community preference information for said user to be developed from personal preference information collected for other ones of said users sharing similar characteristics with said user.

7. The system of claim 6 wherein said community preference information includes community program information developed from personal program information collected for other ones of said users sharing similar characteristics with said user.

8. The system of claim 6 wherein said community preference information includes community setting information developed from community program information collected for other ones of said users sharing similar characteristics with said user.

9. The system of claim 8 wherein upon presenting on said display said personal setting information for said at least one of said respective programs, said user is able to elect between accepting said at least two of the settings, adjusting one or more of said at least two of the settings, or requesting said community setting information for said at least one of said respective programs.

10. A method to facilitate operating a media-playing set including a display comprising:
(a) providing a storage device;
(b) transferring personal preference information to said storage device about the broadcast preferences of said user including personal program information identifying respective programs selected by said user indexed by day and time broadcast and personal setting information identifying at least certain of the settings favored by said user for each respective program; and
(c) enabling said user to selectively access said storage device to recall a portion of said personal preference information associated with a particular day and time including presenting on said display certain of said personal program information identifying at least one of said respective programs and certain of said personal setting information individually identifying at least two of the settings favored by said user for said at least one of said respective programs.

11. The method of claim 10 further including enabling said user to independently adjust each of said at least two of the settings by interacting with said setting information on said display.

12. The method of claim 10 further including prompting said user for geographical information identifying the location of said set.

13. The method of claim 12 further including determining any input sources connected to said set, establishing from said geographical location and said input sources a listing of channels likely available for said set, and selecting said at least one of said respective programs from one of said channels on said listing.

14. The method of claim 10 wherein said storage device is remotely located from and electronically connectible to said set and further including enabling geographically distributed other ones of said users to transfer preference information to and access said storage device.

15. The method of claim 14 further including enabling said user to recall community preference information developed from preference information collected for said other ones of said users sharing similar characteristics with said user.

16. The method of claim 15 further including prompting said user for geographical information.

17. The method of claim 16 further including developing said community preference information from other ones of said users sharing similar channel availability and demographic characteristics with said user as determined at least in part from said geographical information.

18. The method of claim 15 wherein said community preference information includes community program information and further enabling said user to present on said display information identifying at least one respective program from either of said personal program information and said community program information.

19. The method of claim 15 wherein said community preference information includes community setting information and further enabling said user to present on said display information individually identifying at least two settings from either of said personal setting information and said community setting information.
